(19) United States
(12) Patent Application Publication
(10) Pub. No.: US 2003/0179094 A1
(43) Pub. Date: Sep. 25, 2003

(54) Signal-to-product coupling

(76) Inventor: Marcio Marc Abreu, New Haven, CT (US)

Correspondence Address: Jacobson Holman, Professional Limited Liabillity Company, 400 Seventh Street, N.W., Washington, DC, 20004-2218, US

(21) Appl. No.: 10/382,470

(22) Filed: Mar. 6, 2003

Related U.S. Application Data
(60) Provisional application No. 60/362,445, filed on Mar. 8, 2002.

(51) Int. Cl. G08B 23/00

(52) U.S. Cl. 340/573.1; 340/691.6; 600/300; 128/920

(57) ABSTRACT

An automated system for displaying product information related to acquired biological data by a monitoring device. The monitoring device provides an effective and timely manner for manufacturers to reach a user in need of a product associated with the biological data. The system increases compliance by acting at the subconscious level on the user of the monitoring device.

This application claims priority from and the benefit of U.S. Provisional Application Serial No. 60/362,445, filed on Mar. 8, 2002.

### BACKGROUND OF THE INVENTION

1. Field of the Invention

The present invention relates to methods, devices and systems coupling a biological signal to a product related to said signal, and more particularly to a computer based system arranged to display information on products in accordance with the biological signal related to said products, preferably using a subconscious methodology for the operation.

2. Description of the Prior Art

At present, there is no system collecting biological signals that displays useful information to the user on products related to said biological signal. Rather, a typical device for monitoring biological data displays simply a numerical value corresponding to the biological data monitored, but no other useful information.

A major problem is non-compliance with the use of medications, which in turn is the main cause of complications and even fatal events. Checking of blood sugar with a monitoring device may become a routine and the display of only a numerical value may lead the brain to ignore that number since it is a known indicia. That subconscious action may keep the user from using medication needed despite the display of an abnormal numerical value.

In addition, because current monitoring devices only display a numerical value for abnormal biological data, the user has to rely on other means to find potential useful information related to said biological data. Moreover, the manufacturer of a useful product misses the opportunity to help the user by not being able to make the user aware of said useful product.

One example is the pharmaceutical industry which spent millions in advertising on television and printed media to advertise their products. However, there is a low rate of return on these advertisements because the majority of the public exposed to the advertising cannot see the benefit primarily because the exposed audience may have no relationship to the product being advertised. This approach suffers from a number of disadvantages.

First, it is difficult to present the product information to the user in a timely manner. Further, it can be an ineffective process since at the time of exposure to the ad the user may not be in need of the product. In addition, the lack of an integrated system that can also provide information on how to acquire the needed product or information on the needed product means that the user may suffer by not receiving information at the time of need and how to get the product they need. The exposure to an ad for fever medication may go unnoticed by the viewer, but if the same viewer saw the ad for fever at a time that said user had fever, the viewer is more likely to use said medication.

There is thus a need for an automated system for displaying product information related to acquired biological data by a monitoring device, and for an effective and timely means for manufacturers to reach a user in need of a product associated with the biological data, and a system that increases compliance by acting at the subconscious level on the user of the monitoring device.

### SUMMARY OF THE INVENTION

The present invention includes a device that reports information to a user in a subconscious manner that encourages the use of a product to treat an abnormal value displayed in a monitoring device. The present invention yet provides a system that displays information on the product and how to effectively and timely acquire the product.

The present invention provides a monitoring device comprising a computer based signal-to-product coupling in which a signal corresponding to a biological variable (temperature, blood sugar, cholesterol, weight, eye pressure, blood pressure, respiratory rate and heart rate, for example) is coupled to the display of information on products that relate to that signal. Any of the devices described in U.S. Pat. Nos. 5,839,139, 6,120,460, 6,123,668, 6,213,943 and 6,312,393 and published U.S. patent application No. 2002/0049389 can be used as monitoring devices in accordance with the present invention. All of the listed patents and published patent application are hereby incorporated by reference in their entirety.

The present invention provides a product information display system comprising a monitoring device, a server computer that updates said monitoring device when said monitoring device is connected to said server. The server computer has access to the user's biological data containing data to be used in assembling product information to be displayed on the monitoring device.

Product information software executed by the server computer accesses the user database in order to retrieve data therefrom to be used in assembling product information to be displayed on one or more of the display terminals. Whenever monitored biological data is out of range for that user it causes the assembled product information related to said biological data to be displayed on one or more of the monitoring devices or receiver which receives information on the biological data.

The present invention enables the user of a monitoring device to receive product information related to biological data being measured or acquired by said monitoring device. All product information display starts automatically when a user makes a selection or, in the case of abnormal biological data, collected data.

The present invention includes a signal-to-product coupling in which a signal corresponding to a biological variable (temperature, blood sugar, cholesterol, weight, blood pressure, heart rate, respiratory rate, oxygen level, heart rhythm and eye voltage, for example) is coupled to the display of information for products that relate to that signal. The present invention includes a device that reports that information to a user. The reporting device can include a separate unit from the monitoring device or work as the monitoring device.

The invention is based on discoveries for the neuronal pathway structure and the memory function structure in the central nervous system. Whenever one is exposed to familiar indicia, a certain neuronal pathway is activated which leads to a short term memory bank primarily located in the ventromedial and premammillary region of the hypothalamus. Whenever one is exposed to unfamiliar indicia, another neuronal pathway is activated which generally leads to a long term memory bank primarily located in the lateral hypothalamic region. In accordance with the present invention, the neuronal pathways and associated memory banks will be appropriately stimulated to subconsciously encourage the user to seek the instructions and the product displayed to correct the abnormal biological value.

One of the most familiar indicia which everyone is exposed to on a daily basis is numbers. Numbers are part of the daily activity in human life. This type of very familiar indicia (numbers) are held by the immediate or short term memory which holds information close to consciousness only for a few seconds. Although the brain immediately pays attention to numbers since numbers are known to the brain (like one seeing a known friend in the midst of thousands in a football stadium), those numbers are stored in the short term memory. Since they are known there is no need for further exploring their meaning. Unless this familiar indicia (numbers) are repeated several times and then imprinted in the memory bank, it is rapidly forgotten. Usually this type of indicia is retained within the span of attention of only seconds or minutes unless the information is rehearsed by internal repetition. That is why one may rapidly forget a telephone number or cannot remember the blood sugar level measured, or even a date in the calendar.

An unfamiliar indicia (e.g., a name that does not have a meaning) on the other hand is usually retained in the long term memory. This can be retained for unlimited amounts of time after the process of consolidation. Unless affected by disease which includes aging, such memory has limitless capacity. The long term memory usually integrates the meaning, and if the information does not have a particular meaning, the neuronal pathway in the memory bank area remains in a virtual loop in trying to make a meaning of the information stored. The fact that medications and other products have commercial names which are unfamiliar indicia which do not have a meaning, allows for the achievement of the device, system and method of the present invention, and implementation of an effective signal-to-product coupling system.

The preferred embodiment of the invention uses a subconscious technique to help the user remain compliant and use the product that is needed to control an abnormal value measured. Exemplarily, a user is monitoring his/her blood pressure with a monitoring device which has a display and the associated hardware and software in accordance with the principles of the present invention. If the values measured are abnormal, an operation searches the memory and captures a product name related to said abnormal value and displays the name of the product and the abnormal value measured. The unit then displays the alert message in accordance with the principles of the invention using subconscious techniques.

According to the invention the product is coupled to the signal received. A drug (NORVASC™) is associated with, for example, an alert situation in which the drug can be used, which is increased blood pressure. The alert message reads:

Atenolol® alerts: “Blood pressure high—160/100 mmHg was identified at 8:10 PM”

The doctor or patient will naturally pay attention to a blood pressure spike notice, both level of blood pressure and time of occurrence. The numbers which are known to the brain are captured consciously, i.e., by the anatomic correlates of consciousness, a combination of the cerebral cortex and neurons in the brainstem reticular activating system. However, the brand name, which is an unfamiliar indicia is captured subconsciously by visual sensory input, but still unfamiliar indicia is associated with the alert message of high blood pressure.

Numbers are emphasized in the message (level and time) since the brain is set up to pay immediate attention to numbers (familiar indicia) which is captured by the conscious mind, but stored in short term memory since it is familiar indicia. The brand name, however, being unfamiliar indicia is captured by the subconscious mind and stored in long term memory, as if the brain is searching its database to make sense out of unfamiliar indicia. It is as if the brain is trying to make sense of the unfamiliar indicia stored in the memory. Being stored in long term memory, the name of the medication will remain in the patient's mind, who may forget or ignore the high blood pressure value read, but will remain with the unfamiliar indicia (medication name) in a loop circuit.

The permanency of the unfamiliar indicia in the neuronal circuit and long term memory naturally will make the patient remember the medication by association with the high blood pressure level measured. Thus, the system naturally encourages the patient to use the medication. As long as there is an alert or sign of danger and an unfamiliar indicia the brain will remain searching to find the solution. Any related stimuli will lead the patient to remember the medication and the alert message by association.

If the patient hears or sees a similar word such as North, Norway, and the like, the nervous system can bring (not always) the name “NORVASC” to the conscious mind, as if it was asking “Norway, is that what I am looking for?” Although it is not what the brain is looking for, the name of the medication will come to mind and remind the patient of taking care of his/her health, since NORVASC and the alert message will come to mind.

The display can preferably use the font and color used for the brand name in order to increase the sensory input load. If the patient is familiar with the color of the medication (e.g., purple), then whenever purple is received as a sensory input, the brain also will bring to mind other purple indicia it is looking for, such as the medication name and alert message. That will subconsciously encourage the patient to take the medication.

When the patient goes to a store, if the brand is displayed on the shelf, at once the brain will focus on that and erase all of the other brands around, since the brain has been searching for that odd name that was imprinted, and finally the brain found it. The same occurs at the doctor's office and the patient (reminded by the brain) will ask the doctor about the brand name.

Once the patient takes his/her medication and the association between alert message and unfamiliar indicia is dissolved, there is no more urgency to solve the urgent need indicated by the alert message. It is as if the brain had found the meaning for the unfamiliar indicia and solved the problem, and thus there is no need to continue searching. Thus, by naturally encouraging the patient to take their medication, the present invention helps to solve one of the most critical and prevalent problems in therapeutics which is non-compliance with the use of medications.

Preferably, the color of the display could correspond to the brand color and the font of the brand is used which creates a visual and mind imprint. In addition, being perceived visually over time, makes the brand name be imprinted in the memory. The preferred embodiment also includes the availability of further product information. The system thus is comprised of extended memory for further information on the product that can be accessed by “clicking” on an icon on the display. If the doctor clicks on OPTIPRANOLOL™ or ReNu®, a second display screen opens and additional information is displayed (if the icon is used subconsciously, one is more likely to click on it).

The system can be also referred to as customized activities which includes creating and deploying customized information in accordance with the biological variable received from the unit that measures the biosignal (e.g., blood glucose monitor, contact lens that measures temperature, machine that measures cholesterol, scale that measures weight, system that identifies if a woman is pregnant, and the like, herein referred also as a “biomachine”). The signal-to-product coupling also includes coupling of product information to the data entered in the biomachine or information entered in a computer coupled to the biomachine.

A preferred biomachine includes a receiver which receives a signal from a contact lens measuring biological variables in the eye. The customized activities can be deployed and appear in any display means of reporting devices. The customized activities can be deployed to a centralized computer, individual computer, or distributed network to acquire and/or report the information to the user. The characteristics of the customer are used to customize information using computer logic to fulfill the customer needs.

In the event that a user is identified as having a fever, then this user can receive information in the reporting device on fever medications and/or antibiotics, such as TYLENOL and aspirin for fever and BIAXIN as the antibiotic. In the event that measurement of temperature is used for family planning, then the user can receive information on fertility pills, contraceptives as well as fertility clinics and names of doctor specialists in the field of fertility.

The signal-to-product coupling informs the user of the type of product that could be curative or preventive to the condition identified by the signal originated in the biomachine and also informs the user where the product could be acquired, for instance, a type of pharmacy. The signal-to-product coupling includes information on the reporting device related to farming and veterinary products, and the like when the biological variable generated by the biomachine corresponds to values of an animal. The signal-to-product coupling includes all medical as well as non-medical information related to the biological variable originated by the biomachine and displayed on the biomachine itself or the reporting device coupled to the biomachine.

Exemplary reporting devices include any device monitoring biological data or receiving the biological variable signal from an external device (e.g., contact lens on the eye) and which is capable of communicating information to a user including devices such as computers, electronic organizers, cellular telephones, watches, pagers, fax machines, television, radios, or any other device capable of reporting the information or advertising to the user including printed, audio or visual means.

The reporting device includes the display of the biomachine itself, for example, the display of a blood sugar monitor, or the display of a temperature monitor such as a thermometer. It also includes internet appliances, computer devices, pagers, electronic organizers, tablet personal computers, cellular phones or any internet-enabled device receiving or displaying biological data including acquisition of a biological signal and transmission of the signal by a device via the internet, wireless and/or conventional wired means and/or phone lines.

The signal-to-product coupling can also be used to implement pervasive computing, pervasive applications, personal area networks, human computer interface, human computer interaction, and pervasive portals as well as remote medical alerts (predictive and corrective), remote prescription, remote medical diagnosis and remote medical care.

As soon as the abnormal value for the user is acquired, the operation determines the best action based on the signal and informs the user. If the display shows a high sugar level, the display will inform the user of the options for products capable of controlling the abnormal level. Preferably, the user can enter names of medications being used and if an abnormal level related to said biological data is recognized, then the medication name will be displayed. Preferably, the medication name will be displayed using subconscious means to increase compliance by subconsciously stimulating the patient to use the medication needed to control said abnormal value.

The monitoring devices can preferably have capabilities to be connected to a central server by wired or wireless means to receive updates on products related to biological data being monitored.

The present invention enables the display of product information to the user in need of such product using an operation that matches the abnormal biological data with a product to control said biological data. Exemplarily, a machine to monitor cholesterol has in its database the abnormal values stored. If said abnormal values are acquired during measurement, the system captures the product information related to said abnormal data and displays the information on the display of the monitoring device or on the reporting device.

It is understood that the user can set the abnormal values for that particular user. In this case, the values are stored in the field “abnormal values” of the memory. Each time the user enters the function “abnormal value”, the value entered is stored and considered abnormal for that user. Whenever this abnormal value is measured, the product information associated with said abnormal value is displayed. It is understood that the user can set the “product required” for that particular user. In this case, the names are stored in the field “product required” of the memory.

Each time the user enters the function “product required”, the name entered is stored and considered the required product for that user. Whenever an abnormal value is measured the “product required” name is associated with said abnormal value and displayed. It is understood that the product required field can have a physically installed product name and information in addition to product required entered by the user.

In another preferred embodiment of the invention, each monitoring device is provided with software for matching product to signal. Users provide custom information in the form of abnormal values, drugs used, personal information, medical history and the like The information appearing on the display can relate to anything about the user, such as, diseases being treated, allergies, drug interaction and the like. In addition the user can enter personal information such as doctor's name, preferred pharmacy, laboratory, hospital and the like. If a certain drug is needed, information on where to acquire the drug can be displayed, and a request to fill a prescription generated if requested by the user. The monitoring device preferably has connectivity means if the user has a fever, and if the user entered aspirin for fever, then aspirin is displayed. In addition, the touch screen allows the user to press send to transmit a request to the pharmacy to buy aspirin. Exemplary software and hardware for the operations required were described by in published U.S. patent application 2001/0056359.

If using a scale and excess weight for that user is measured, operation of the system may display different information according to the degree of severity of the abnormal value measured. If a mild weight gain is noticed, a product will be displayed that could help better control such weight such as low calorie food or food groups. If a moderate increase in weight is measured the product information may include a suggestion for an exercise machine and settings for achieving proper weight. If a severe increase in weight is measured, the product information may include a clinic for weight loss.

If a user is measuring blood sugar and just a mild change is noticed, product information can include the name of the product needed with an associated reminder message to take the medication. If sequential abnormal values are acquired, it could indicate lack of availability of medication, and then logic determines the need for a possible refill of the medication. Thus product information displayed will include the name of the medication and a message reminder to refill the prescription.

The system of the invention can also be used in a hospital setting in devices monitoring biological data of patients admitted to a hospital. In this case the drug associated with the alert message is preferably a drug used in the hospital setting.

Exemplarily, display of a hospital monitor with alert message sponsored by AUGMENTIN™ may be made. A drug (AUGMENTIN™) is associated with an alert situation in which the drug can be used, (temperature spike) which may indicate infection. Color of the display could correspond to the brand color and the font of the brand is used which creates a mind imprint. The doctor or patient will naturally pay attention to the temperature spike notice, both level of temperature and time of occurrence, but the brand name is captured subconsciously. If the doctor clicks on the name AUGMENTIN™, a second display screen opens and information on the drug is displayed such as indications and dosage. An icon is preferably used since subconsciously one is more likely to click on an icon or a name that is underlined.

For the sake of completion it is understood that the present invention allows the manufacturer of the monitoring device to charge a company displaying their products in the monitoring device according to how long the product is displayed or how many times each product name was seen by the customer. The manufacturer can acquire that information when providing software updates to the user. In addition, the company's name and products to be displayed could be installed during fabrication of the monitoring device.

A signal from the monitoring device and/or the characteristics of the customer are used to customize product information using computer logic to fulfill the customer needs and signal received. The system and device of the present invention includes delivering personalized information that enhances and preserves a users' well being and health. The system includes the matching of patients' needs with drugs available, making patients aware about drugs available for medical problems, a reminder to take medications and fill/refill prescriptions and thus increase compliance in addition to encourage a patient to seek medical help and get medications in accordance with the severity of the abnormal biological data.

The system of the invention includes specialized designs for several population segments:

1. Health Care Provider—monitor in hospital or nursing facility

2. Patients—home monitoring for disease

3. Public in general—preventive monitoring

Different Alert names are displayed according to target population:

1. monitor in hospital or nursing facility→Alert message for associated drug used in hospital setting

2. home monitoring for disease→Alert message for drug that can treat the disease of the patient

3. preventive monitoring→Alert message for a general product

The target population also defines the content that should be displayed on the monitoring devices. For professional use, information relevant to doctors may be associated with the clicking of the icon. Information for patients may be more restricted to general information about the product.

The user can preferably add, update and delete information about products in the monitoring device. In addition, the user and/or manufacturer can specify a time schedule for the product name and information display.

Product information stored in the monitoring device may consist of HTML information, static image information, digital video information and the like.

Additional features and advantages of the present invention will become apparent by reference to the following detailed description and accompanying drawings.

### BRIEF DESCRIPTION OF THE DRAWINGS

FIG. 1 is a diagram of the components of the monitoring device according to the present invention.

FIG. 2 is a front view of an exemplary embodiment of a monitoring device in accordance with the present invention.

FIG. 3 is a perspective view of an exemplary monitoring device and display of signal-to-product coupling for monitoring glucose levels.

FIGS. 4A-4F show an exemplary display of signal-to-product coupling using subconscious means in accordance with the present invention.

FIG. 5. is a diagram of the components of a system in accordance with the invention.

FIG. 6 is a flow chart illustrating an exemplary sequence of operating steps that can be used for retrieving appropriate product information based on biological data for display on a given display device according to the principles of the present invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

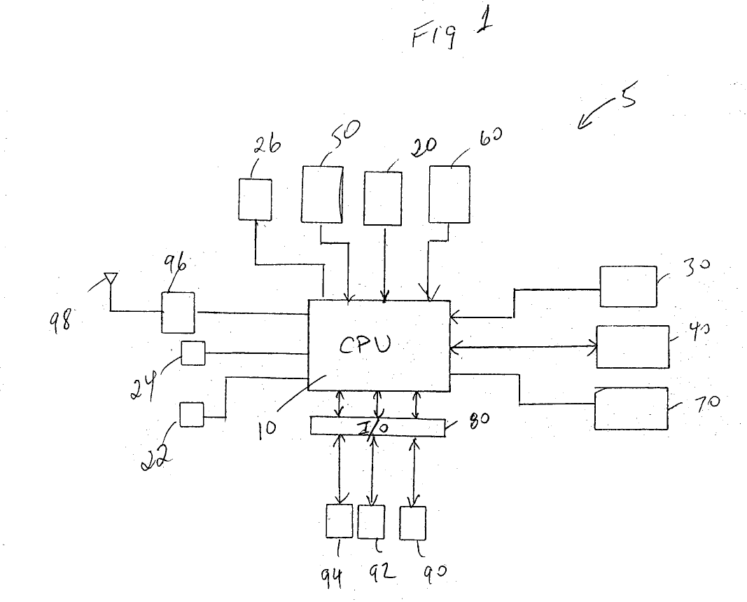

FIG. 1 shows a diagram of a preferred embodiment of the monitoring device of the invention. The user provides inputs to the touch-screen display 70 by touching indicated areas of the screen display that function as buttons. Additional input and output devices may be added, as desired. Although the present embodiment makes use of a hand held personal device, it would be within the spirit of the invention to use other devices monitoring any biological data as well as devices connected by the internet or other means of remote access, so that a user can be remotely alerted in accordance with the principles of the invention.

In this embodiment, the abnormal biological data value is transmitted over the internet to the user. The display of the information follows the format in accordance with the principles of the invention concerning specific biological data monitored and the product information is displayed, which is associated with said biological data. In addition, the display of the information in a computer screen using the architecture disclosed herein for subconscious delivery of an alert message is also within the scope of the invention.

The block diagram of FIG. 1 shows an exemplary monitoring device 5 comprising a microprocessor (CPU) 10, sensor 20, a power source 30, memory 40, touch screen 50, keypad 60, display 70, I/O ports 80, communication ports 90, an optical transceiver 92 and a conventional modem 94 which can be connected to a remote central server via electronic or conventional communication means. In addition, alternatively, the system can include an RF transceiver/modem 96 coupled to an antenna 98 for wireless transfer of data, visual indicators (e.g., warning lights 22) and audible indicators (e.g., speaker 24) and a microphone 26.

At least one output from the sensor 20 is supplied to microprocessor 10 which in turn is supplied to the display 70 through a conventional LCD driver circuit that conventionally decodes and multiplexes the data to be applied to the display 70. Memory unit 40 stores the product information and values and parameters related to the displaying of product information and alert messages.

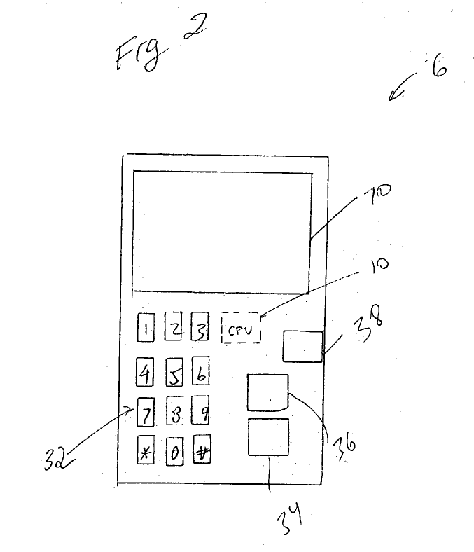

FIG. 2 shows a frontal view of the housing of a monitoring device 6 to measure cholesterol levels for home-use with a display 70, keypad 32 for selection of information entered, key button 34, function button 36 and sensor port 38 for introducing specimen to be measured, in addition to CPU 10 housed inside the monitoring device. It is understood that any device measuring biological data can be used in accordance with the principles of the invention including home-measuring devices, such as a self-tonometer to measure eye pressure at home, as previously described by reference; a non-invasive self-measurement system for blood cholesterol, as described by reference; a continuous temperature measuring device as described by reference; a heart rate and rhythm monitor; as well as a conventional electronic blood pressure measuring device, electrocardiograph, electronic scale, and the like. It is understood that any other device capable of measuring any physical or chemical biological variable can be used in accordance with the principles of the present invention. Sensor port 38 receives and stores the information on the values of the biological data, i.e., cholesterol level, and said biological data is fed to and received by the microprocessor 10 for determining the information to be displayed by display 70.

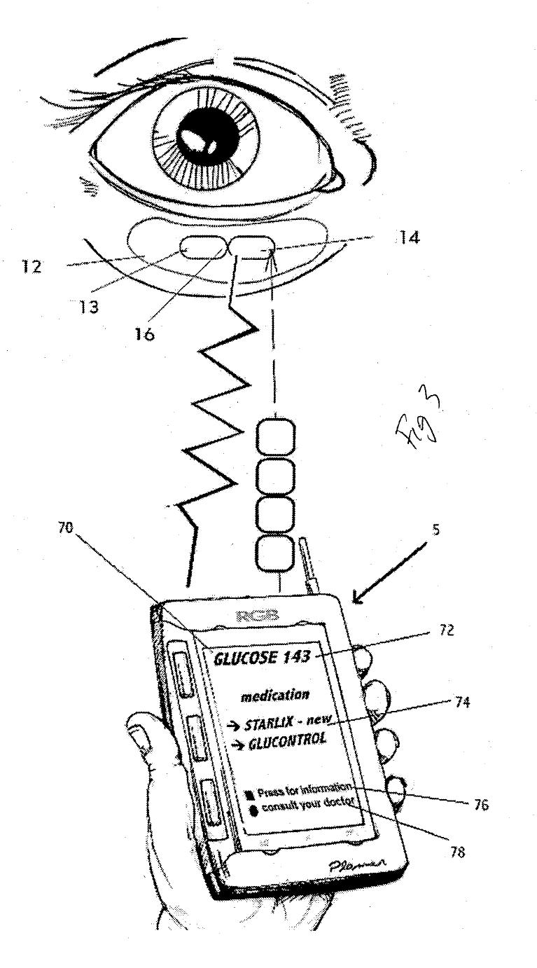

FIG. 3 is a perspective view of yet another embodiment of the present invention comprising an intelligent contact lens unit 12 for measuring glucose with transmitter 14, sensor 16 and processor 13. This unit 12 is linked to monitoring device 5 that includes a display 70 with field 72 displaying the numerical value of the biological variable measured (in this case, glucose), field 74 displaying the product name related to the value measured and signal received (in this case, the patient is a diabetic and was using two drugs for diabetes namely GLUCOTROL and STARLIX), field 78 which displays a link to a communication means to connect with the user's doctor and field 78 that displays a link to more information which can include a pharmacy to find the medication or more information on the drug being displayed.

If on the other hand a normal level is measured, then the display can read “Glucotrol inform—Normal value of 100 was identified in the last measurement”. In this case, the time of measurement can be omitted. Since there is no urgency or concern, the brain automatically discards the information. Although, the repetition of sensory input with the name of the drug can lead to a consolidation process and storage in the long term memory due to rehearsing, the name of the drug does not enter in the neuronal circuit in the same manner when there is an alert and possible danger to the body. The first instinct is for preservation and the brain remains in a state of alert when there is potential for change in the status of preservation of life.

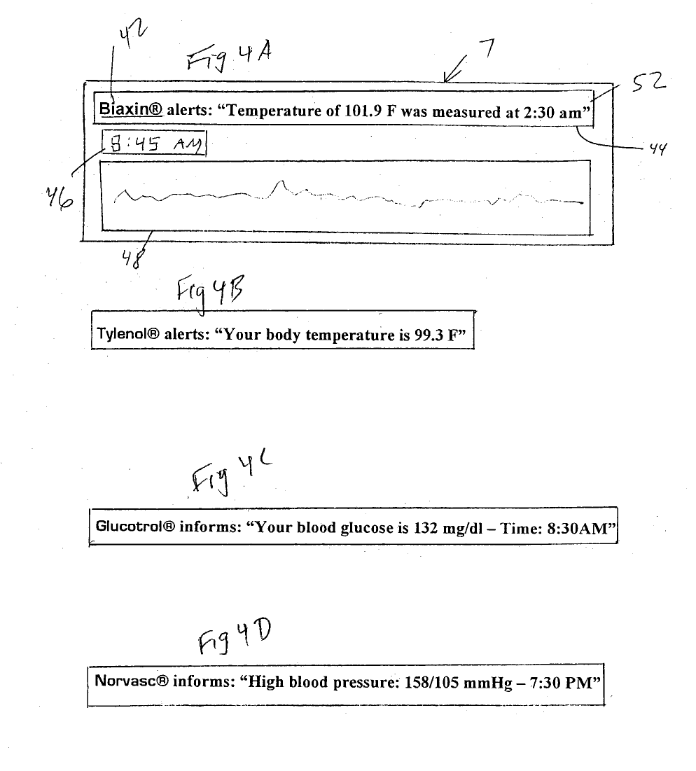

FIG. 4A shows a diagram of another embodiment of the present invention comprising a monitoring device used in hospitals. Monitoring device 7 is a device thermometer for continuous measurement of temperature that comprises a clock 46 showing real time, a tracing 48, a display 44 for displaying alert message in accordance with the present invention. Display 44 has field 42 comprising an icon for the medication BIAXIN and field 52 for the alert message.

The monitoring device 7 is measuring temperature. Since the signal received indicates a spike in temperature, the display of the device shows the name of the product that can be used to correct the abnormal biological data, in this case, the spike in temperature may indicate an infection. If so, an antibiotic “BIAXIN” is displayed with the alert message. When used in the hospital setting the signal-to-product coupling can include a message such as: “BIAXIN alerts: At 2:30 AM a temperature of 101.9° F. was identified” BIAXIN dosage: 500 mg daily. The extra information (dosage) may help expedite therapy of the patient in case there is a determination to use BIAXIN to treat the patient. If the biological data monitored was heart rate, then the alert message reads: “AMIODARONE informs: At 4:20 AM heart rate of 160 was identified”. For more information on AMIODARONE click on the icon. AMIODARONE is an anti-arrythmic drug that can be used to control tachycardia (increased heart rate as presented here).

FIG. 4B shows another diagram with a alert message in a home use thermometer with alert message; “TYLENOL alerts: Your body temperature is 99.3° F”. If the temperature was measured but only a numerical value would appear, although depending on the person and clinical condition, in most cases the brain would ignore this and the person would not take a fever medication. However, when the name of the medication appears associated with the numerical value, there is a dual sensory input with familiar and partially unfamiliar indicia (TYLENOL). This combination of input to the conscious and subconscious mind will lead to sustained attention. The viewer then more likely will use the medication. This can be important for the elderly, who may ignore the value, and by not controlling their fever be at risk of febrile convulsions. As can be seen in this embodiment, although time (hour/minute) increases sensory input, said time (hour/minute) does not need necessarily to be present for the implementation of the invention.

FIG. 4C shows another exemplary diagram with an alert message in a home use blood glucose monitor with alert message: “GLUCOTROL informs: Your blood glucose is 132 mg/dl—Time 8:30 AM”. This message will lead to sustained mental attention to the high level. A diabetic knows what the normal and high levels for glucose are, and by associating a solution to the problem, i.e., the medication that solves the problem, mental action which is followed by physical action will more likely be taken. This can be important for diabetics who tend to be non-compliant, and by enhancing compliance by the use of the present invention, complications due to diabetes can be prevented.

FIG. 4D shows yet another exemplary diagram with an alert message in a home use blood pressure monitor with alert message: “NORVASC informs: High blood glucose: 158/105 mmHg—7:30 AM”. This message will lead to sustained mental attention to the high blood pressure level. The indicia “high” or any other indicia that indicates danger associated with a familiar indicia “number” and yet associated with unfamiliar indicia “medication name” leads to a high sustained level of mental attention. Since the combination of sensory input includes a solution for the problem, medication that corrects the high blood pressure level, there is the mental perception of purposeful activity, meaning taking an action that solves a problem. This mental perception of purposeful activity is carried by the “conscious” pathways including the ascending reticular activating system in the brainstem and thalamic regions. That mental activity is related to physical action, in this case, taking the medication to correct the problem. In addition, the combination of sensory input described leads to coherence of reasoning and logical thought which can be fabricated by the mind and the physical action to be taken. Once that occurs physical action is almost invariably taken to correct the problem. In the unlikely event that the patient still ignores the danger, the subconscious pathways as previously described will be a gentle but consistent reminder of a problem that needs to be solved.

FIG. 4E shows a further exemplary diagram with an alert message in a home use scale with alert message: “Weight alert: 7:30 AM—You are 26 pounds above your ideal weight. Please contact Dr. Kieferman”. The user entered the doctor's name in their unit, which can mean that the doctor is supervising the weight reduction program, since if the weight becomes a serious and imminent danger to the user's health, the doctor's name will appear associated with the indicia related to the danger. Since going to the doctor can give an opportunity to control the danger “indicia” there is a mental perception of purposeful activity, coherence of reasoning and logical thought as described previously. It is understood that a variation of the alert messages with soft or stronger wording, or different wording can be used and are within the scope of the present invention.

Although the primary purpose of the invention is to preserve life and health, others can benefit. For the sake of completion, an alternative embodiment that can be used for promotional activities is described in FIG. 4F. Accordingly FIG. 4F shows yet another exemplarily diagram with an alert message in a home use scale: “Low fat POST cereal informs: you are seven pounds above your ideal weight—6:45 AM”. The sensory input related to the name of a product that can help correct the problem or danger leads to mental perception of purposeful activity, coherence of reasoning, and logical thought as previously described. The mental sustained perception is stored until the problem is addressed. If the actual logo of the product, and colors of the product are used, the increased sensory input will further stimulate fabrication of a mental task, in this case, to use a low fat cereal. The brain does not perceive POST as logical indicia, since the actual word “post” has no relation with cereal or low fat. This leads to storage of the indicia (POST) in the memory bank as the brain is trying to make sense of the relation ship between POST and food. Once the user is at a store, the brand will “jump” at him/her since the brain is looking for that indicia. Most brands can be used since the brand names usually are either unfamiliar indicia (e.g., drugs) or not logical indicia (word post means station or position, not cereal).

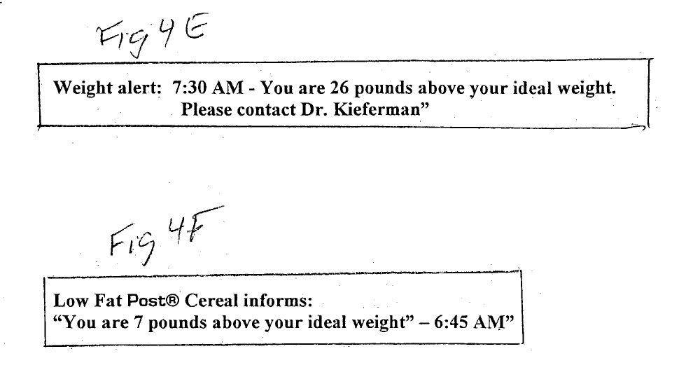

FIG. 5 is a block diagram of the system 120 of the invention. The user's monitoring system 100 is connected to the central server 110 by link 112. It is understood that the device 100 preferably acts as a computer system with communication capabilities which allow a direct connection between the device 100 and the central server 110. In this regard, the monitoring device 100 can acquire and transmit to the central server 110 both biological variables and product information stored in memory unit 116. The transmission of data preferably is performed via programming within the monitoring device 100. It also is understood that any means for transferring biological data and product via a network such as the Internet can be employed by the present invention.

The biological variables can be analyzed against the product identification information stored in the central server 100 for monitoring device 110. Central server 110 then can provide to device 100, at the user's authorization, information on products that can be beneficial to the abnormal biological data that was measured. The system 120 also allows for direct wired and wireless communication and duplex transmission between monitoring device 100 and the central server 110.

As shown in FIG. 5, the monitoring device 100 includes central processor 114 and memory unit 116 for controlling operations of said device 100 with said central processor 114 interconnected to the other parts of the monitoring device 100 and being programmed so as to provide suitable control over the individual operational elements described herein. The monitoring device 100 will preferably have communication means and data communication link 112 providing for a suitable telephone line connection, cable, wireless and the like, so as to enable communication with the central server 110 over conventional telephone lines, the Internet, wireless, and the like. Data communication link 112 is operatively interconnected with the central processor 114 for communicating data between the central processor 114 of device 100 and the central server 110. The memory unit 116 at the monitoring device 100 can be used for storing product information and biological data. The central processor 114 at the device 100 can be programmed to permit storage and transmission of product information and biological data to/from the central server 110.

The database and operational steps that can be used to implement the method of the present invention was previously described in the aforementioned published U.S. patent application.

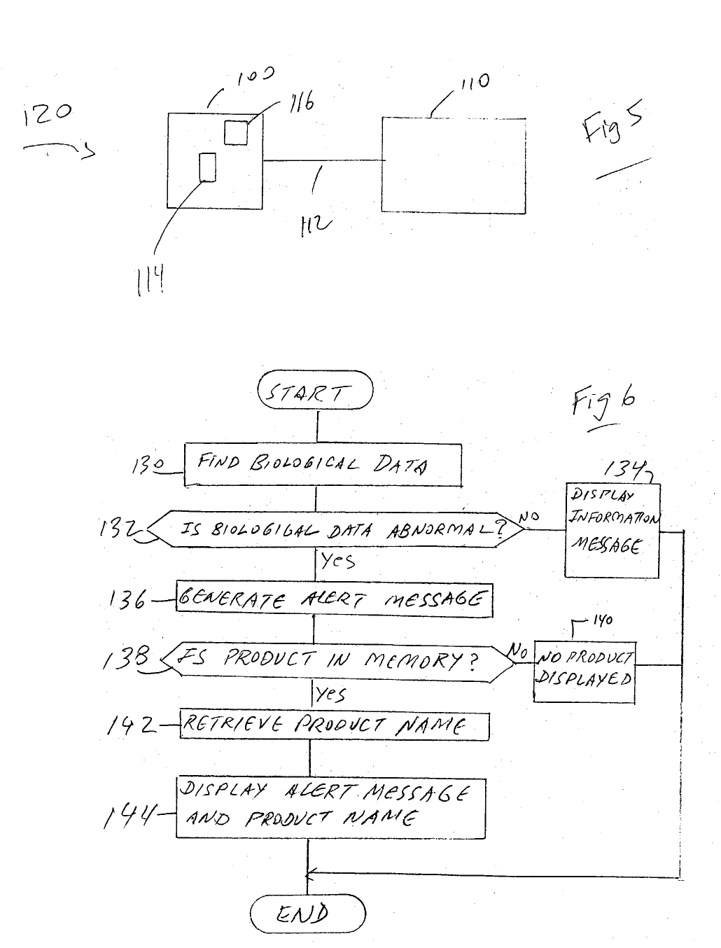

FIG. 6 is a flow chart illustrating an exemplary sequence of operating steps that can be used for retrieving appropriate product information based on biological data for display on a given display according to the principles of the invention. The method includes the following steps:

Find biological data: first, operation finds the biological data measured (step 130). Then step 132 determines whether the biological value is normal for the user. If not, an information message is displayed, not an alert message (step 134). If yes, then an alert message is generated at step 136. Next, processing continues to determine at step 138 whether there is any product in the memory that is related to the abnormal biological data and that can control the abnormal biological value. If not, then no product name is displayed (step 140). If yes then a name of a product is retrieved at step 142. The operation then displays on a given display the alert message and associated product that can control the abnormal biological data measured (step 144), and processing ended.

The foregoing description of the preferred embodiments of the present invention have been provided for the purposes of illustration and description. Many modifications and variations will be apparent to those skilled in the art. The embodiments were chosen in order not to limit the scope of the invention but to best explain the principles of the invention and its practical applications.

I claim:

1. A system for displaying product information related to acquired biological data, said system comprising:
a sensing device for obtaining biological data, and
a monitoring device displaying product information dependent upon the biological data obtained by said sensing device.

2. The system as claimed in claim 1, wherein the monitoring device includes a display device for displaying both the biological data and the product information.

3. The system as claimed in claim 2, wherein the biological data and the product information are displayed simultaneously.

4. The system as claimed in claim 3, wherein the biological data is outside of normal parameters and an alert message is displayed.

5. The system as claimed in claim 1, wherein the monitoring device is connected to a server computer for updating the monitoring device.

6. The system as claimed in claim 1, wherein the monitoring device includes a reporting device for reporting information to a user.

7. The system as claimed in claim 1, wherein the product information includes at least one of a brand name, color of the medication, color of packaging and font style.

8. The system as claimed in claim 1, wherein the sensing device is a contact lens.

9. The system as claimed in claim 1, wherein the biological data is one of glucose, temperature, cholesterol, weight, pregnancy status, eye pressure, blood pressure and heart rate.

10. The system as claimed in claim 3, wherein the biological data is within normal parameters and an information message is displayed.

11. A system for displaying information related to acquired biological data, said system comprising:
a sensing device for obtaining biological data, and
a monitoring device displaying one of an alert message and an information message dependent upon the biological data obtained by said sensing device.

12. The system as claimed in claim 11, wherein product information is included with said alert message.

13. The system as claimed in claim 11, wherein the monitoring device includes a display device for displaying both the biological data and the one of the alert message and the information message.

14. The system as claimed in claim 11, wherein the alert message is displayed when the biological data is outside of normal parameters.

15. The system as claimed in claim 11, wherein the monitoring device is connected to a server computer for updating the monitoring device.

16. The system as claimed in claim 11, wherein the monitoring device includes a reporting device for reporting information to a user.

17. The system as claimed in claim 12, wherein the product information includes at least one of a brand name, color of the medication, color of packaging and font style.

18. The system as claimed in claim 11, wherein the sensing device is a contact lens.

19. The system as claimed in claim 11, wherein the biological data is one of glucose, temperature, cholesterol, weight, pregnancy status, eye pressure, blood pressure and heart rate.
